(19) United States
(12) Patent Application Publication
(10) Pub. No.: US 2010/0289922 A1
(43) Pub. Date: Nov. 18, 2010

(54) Method and system for processing data sets of image sensors, a corresponding computer program, and a corresponding computer-readable storage medium

(75) Inventors: Thomas Brenner, Berlin (DE); Henrik Battke, Berlin (DE); Frank Gaebler, Berlin (DE)

Correspondence Address: LONDA, BRUCE S.;NORRIS MCLAUGHLIN & MARCUS, PA, 875 THIRD AVE, 8TH FLOOR, NEW YORK, NY, 10022, US

(73) Assignee: BIT-SIDE GMBH, BERLIN (DE)

(21) Appl. No.: 12/302,590

(22) PCT Filed: May 25, 2007
(86) PCT No.: PCT/EP2007/055090

§ 371 Date: Nov. 30, 2009

(30) Foreign Application Priority Data
May 29, 2006 (DE) 10 2006 025 651.4
Feb. 2, 2007 (DE) 10 2007 005 998.3

(51) Int. Cl. H04N 5/76; H04N 5/228

(52) U.S. Cl. 348/231.99; 348/E09.002

(57) ABSTRACT

The invention relates to a method and an arrangement for processing records of imaging sensors, a corresponding computer program, and a corresponding computer-readable storage medium which can be used particularly for creating panoramic photographs with the aid of mobile terminals, e.g. a digital camera, a mobile telephone, or similar. In said method for processing records of imaging sensors, several successive records of an imaging sensor are read at least in part, records read during reading of additional records are analyzed in order to determine matching areas within the read records, and data of several successive records is combined to a panoramic image during output via data output means.

The invention relates to a method and a system for processing data sets of image sensors, as well as a corresponding computer program and a corresponding computer-readable storage medium, which can be used in particular for creating panorama photos using mobile terminals, such as a digital camera, a mobile phone and the like.

Devices for creating panorama photos are already known. However, the known solutions always employed optical units for imaging the motifs in the desired panorama format on the optical or image sensor, for example an (analog) film or a CCD chip. However, the employed optical units always required additional material. Sometimes very high additional costs are incurred, in particular, with high-end, high-quality devices or with devices capable of capturing extreme wide angle shots.

Other known methods, for example those used in digital cameras, require the user to manually position and orient the camera with the necessary overlap for later combining the images either automatically or through a manual correction. The enhanced methods display to the user, for example, a semi-transparent vertical strip from the last image to facilitate positioning. This is frequently problematic with difficult scenes having similar objects, for example a rock wall.

In another practice, a video is recorded, from which the panorama is subsequently extracted by image analysis. However, this requires storage of a large number of data sets in a memory with limited capacity, which quickly reaches its limit for images of higher resolution, in particular in miniaturized devices such as digital cameras and mobile phones, and also reduces the quality, because the individual images of the video recordings are typically of poorer quality. A decision about the images required for the panorama can typically not be made during recording.

Another option is to record and store a large number of individual images, wherein the memory requirement and the processing time increase with the image capture angle and with the resolution and hence also the quality of the individual and combined images, all of which exceeds the capability of miniaturized devices.

Neither method provides the user with a preview of the emerging image, but displays only the currently recorded image/data set. Data sets already recorded are not displayed.

The Japanese published application JP 2006-135386 describes a method wherein video images of several cameras are combined into a panorama image. More particularly, those individual images of all cameras are combined into a panorama image which were recorded by the different cameras at the same time. However, JP 2006-135386 does not describe processing of time-sequential images.

It is therefore an object of the invention to provide a method and a system for processing data sets of image sensors, as well as a corresponding computer program, and a corresponding computer-readable storage medium, which obviate the disadvantages of the known solutions and allow more particularly automatic recording of panoramas with a freely selectable recording angle.

The object is attained with the invention with the features recited in claim this 1, 17, 23 and 24. Advantageous embodiments of the invention are recited in the dependent claims.

According to a particular advantage of the invention, panorama photos can be recorded with devices such as, for example, mobile phones, which do not have a special panorama optical system, and are only equipped with standard lenses. These recording capabilities are enhanced with the method of the invention for processing data sets of imaging sensors by reading with a data processing unit data sets of an image sensor at least partially in rapid succession. While additional data sets of the image sensors are being read out, preceding data sets already read out are analyzed (preferably automatically) to determine matching regions within the read-out data sets. Preferably, the read-out data are analyzed as image data, whereby matching image regions are searched in the image data sets. All suitable methods for image processing can be used. Based on the determined, matching regions, i.e., the matching image regions, data sets of several consecutive data sets are combined one-by-one into an aggregate image. This aggregate image includes data which display a scene that is larger than the scene that can be displayed by a single data set of the image sensor. Advantageously, the data generating the aggregate image are stored together and/or outputted by data output means. The data of the aggregate image are outputted visually or transmitted to other data processing devices as a file, for example for additional processing.

Preferably, the method of the invention reads complete data sets from the image sensors. However, a very low resolution can be used for analyzing the image data, which enables also low-performance devices to rapidly read the data.

An arrangement for processing data sets of image sensors according to the invention includes at least one image sensor and at least one data processing device with storage means or at least one image sensor, at least one data processing device with storage means and at least one means for data output, wherein the arrangement is configured so that several consecutive data sets of the at least one image sensor are at least partially read out, read-out data sets are analyzed to determine matching regions within the read-out data sets, and data sets of several consecutive data sets (preferably from a single image sensor) together with information about matching regions are stored in the storage means and/or outputted by means for outputting data, wherein in one output, preferably a visual output, data of the at least one image sensor are merged into a single image. With a visual output, the image data sets are preferably displayed on a display and the image displayed on the display is expanded gradually with image data of subsequently read-out data sets. In a preferred embodiment of the arrangement of the invention, the image sensor is a CCD sensor (CCD=Charge Coupled Device) or a CMOS sensor (CMOS=Complementary Metal Oxide Semiconductor).

In a preferred embodiment of the arrangement according to the invention, an optical unit for imaging scenes on the at least one image sensor is placed in front of the image sensor. The optical unit is preferably a lens system, for example a camera objective.

Advantageously, the arrangement of the invention may include an activation unit for activating the read-out of the data sets from the image sensor. Such activation unit can be implemented in a camera or in a mobile phone with camera function, for example, as a shutter release.

The means for data output preferably also include means for visually displaying the data of the at least one image sensor.

In a preferred embodiment of the method of the invention, the activation unit activates a shutter release function, wherein several consecutive data sets of the image sensor are read out during a permanent activation of the shutter release function. Preferably, the data sets are permanently read out when the shutter release function is activated, i.e., individual images are read out sequentially in rapid succession.

According to a preferred embodiment of the arrangement of the invention, the at least one image sensor is integrated in a mobile terminal, for example a digital camera, a Personal Digital Assistant (PDA) or a mobile telephone. The activation unit is in these situations a shutter release. As long as the shutter release is depressed, data sets are read out from the image sensor, analyzed and combined into an aggregate image. Alternatively, the shutter release operation can also be started by a first one-time actuation of the activation unit and terminated by a second one-time actuation of the activation unit. The shutter release function is activated and data sets are read out from the image sensor between the time the activation unit (shutter release) is depressed and the time the activation unit (shutter release) is released, or between the first and the second one-time actuation of the activation unit. The data sets or at least a portion of the data sets, which are read out during this one-time continuous activation of the shutter release function, are combined into an aggregate image. A panorama image is produced by moving the image sensor relative to the scene to be detected during read-out of the data sets. If the image sensor is integrated in a mobile terminal, for example a mobile telephone, a digital camera or a PDA, a panorama image is produced by panning the mobile terminal while the shutter release is depressed and the desired scene is recorded. Combined images in form of a panorama image can also be obtained by taking photographs from a moving vehicle, without moving the camera. Accordingly, the image sensor and the scene to be detected need only move relative to one another.

According to another preferred embodiment of the method of the invention, a 2-D transformation between two consecutive images, i.e., between two consecutively read out image data sets, is determined in the analysis of the read-out data sets. Preferably, this 2-D transformation is determined by 2-D-homography or a projection transformation. The projection transformation can simply be performed, for example, as a Lukas-Kanade algorithm.

Advantageously, the data sets are analyzed continuously or in real time. In particular, the analysis advantageously also produces data about the path of the image sensor across the scene, for example, from the optical flux of the sequentially read-out image data sets.

According to another preferred embodiment of the method of the invention, the results from this analysis are used to determine when an additional data set is required for the combined image of the scene and must therefore be stored and/or how this partial image is to be added to the already stored partial images. Preferably, this determination is performed fully automatically. The term partial image refers to a portion of the (generated) panorama image.

According to another preferred embodiment of the invention, data sets of different resolution are read from the image sensor. The analysis can also be performed with data sets having a relatively low resolution. For this reason, only image data with low resolution are read out. If a new data set is to be added to already stored data, then this data set is read out with higher resolution (and stored). This approach results in faster processing, because the analysis needs only to be performed on small data sets; in addition, less storage space is required for the analysis.

The next image that must be added with adequately overlapping features, is determined as described above; however, until such image is added, only low-resolution data are read out from the image sensor (e.g., so-called viewfinder frames). An image with enhanced, preferably complete image acquisition control (e.g., autofocus, exposure measurement, white balance, flash . . . ) is read out only when an additional image is to be added. When recording with improved image acquisition control, additional parameters, such as auto focus, exposure measurement, white balance, flash and others are taken into consideration when recording an image to be added to the created panorama image, depending on the user requirements and/or the scene characteristic (lighting conditions and the like). These parameters are determined by the camera system anew for each recording; alternatively, these parameters can also be a preset for recordings.

Because an image recorded with improved or preferably complete image acquisition control typically experiences shorter or longer delays, depending on the camera type, an audio and/or visual message can request that the user stop the camera motion.

In a preferred embodiment, the already measured parameters are used to check if the motion has stopped, and only then is the image acquired.

After the image is acquired, the preview on the display is updated and the user is requested through audio and/or visual information to continue the camera motion.

Pausing/stopping the camera motion also has the advantages that:
a) The camera motion can be faster until it is stopped, and
b) Motion blurring may be entirely prevented depending of image sensor and objective as well as the scene characteristic (e.g., illumination and distance);
c) A flash may be triggered.

Stopping the motion and acquiring an image with improved image acquisition control by taking into account additional parameters also has the following advantages:
a) Image data can be recorded which are combined later, because they do not fit, for example, in the main memory and are written by a hardware-supported encoding unit (e.g., typically in mobile telephones with camera function) directly into a non-volatile permanent memory (e.g., flash, hard disk, . . . ). To this end, the higher-resolution images and the transformations determined from the individual, potentially lower-resolution images and extrapolated to higher resolution are stored for the mixing.
b) Those devices which do not allow the image data to be read directly from the image sensor, and which only provide viewfinder frames, and which like the devices mentioned under a) always use an encoding unit for directly storing image data at higher resolution, can be supported with automatic panorama function by interrupting the motion while the panorama images are recorded.
c) The 2-D transformation between two consecutive images can be refined based on the higher-resolution data sets and with additional processing time based on the already determined transformations, and/or can be computed anew, for example by using methods that require more computing time.

According to a preferred embodiment, the lower-resolution image data (e.g., viewfinder frames) can be combined, as described above, for computation and preview, whereas the higher-resolution image data are combined in a post-processing operation.

The aforedescribed image acquisition method, wherein a user is informed by a feedback signal (audio/visual information), when the camera motion should be paused to obtain recordings in the desired quality, is only made possible by the method of the invention for analyzing the image data sets, because the analysis allows conclusions about the data sets of the image sensor that are required for an image. In one embodiment, the analysis may conclude that the camera motion is too fast for an added image to be recorded, which is then indicated to the user. If the image to be added to the panorama can be recorded with the present speed and with the selected quality, then preferably no signal is sent out.

In another preferred embodiment of the invention, the image to be added is recorded even if the motion of the camera is not paused or is paused only after a delay. Because an image of lower quality may have been recorded under these circumstances, this image can later be overwritten with a higher-quality image.

In another preferred embodiment of the invention, the user can be requested, if the motion is paused too late, to perform an opposite motion.

According to another preferred embodiment of the invention, the user can be requested, if the image quality is poor, e.g., motion blurring, to perform an opposite motion, so as to still be able to record a higher-quality data set.

According to another particular advantage of the method of the invention, unlike with a conventional data analysis, not all read-out data sets need to be stored for later use. As long as the analysis of the read-out data sets shows that a read-out data set does not yet need to be added to an already stored data set, this data set also does not need to be stored. For example, the overlap of the currently read-out data set with the already stored image may include additional image regions, and the analysis may show that the overlap between the already stored image and the subsequently read-out data set is adequate for generating the panorama image, in which case the preceding data set can be deleted. The subsequent data set is optionally stored—unless the immediately following data set is better suited for composing the panorama. With this approach, the required memory size can be significantly reduced.

In another preferred embodiment, progress during the generation of the panorama image can be evaluated by displaying the evolution of the panorama image continuously and/or as real-time preview on visual output means, preferably a display or screen of the recording device. Such real-time preview is an inducement for using the invention, because the user can observe the recording process in a real-time preview and then change, for example, the speed of the manual motion to optimize the outcome.

A computer program for processing data sets of image sensors enables a data processing device, after the computer program is loaded into the memory of the data processing device, to execute a method for processing data sets of image sensors, wherein

several consecutive data sets of an image sensor are read out at least partially, read data sets are analyzed to determine matching regions within the read-out data sets, and
data of several consecutive data sets together with information about corresponding regions and/or
data of several consecutive data sets are stored in a file and/or
data of several consecutive data sets are combined into a single image when outputted by means for data output.

Such computer programs may, for example, be provided for downloading (for a fee or free of charge, freely accessible or password-protected) in a data or communication network. The provided computer programs can then be used by a method, wherein a computer program according to claim 22 is downloaded from an electronic data network, for example from the Internet, to a data processing device connected to the data network.

For example, with the method of the invention, pictures may be taken during a gathering of several friends, e.g., at a party, of all attendees with a “rotating snap shot” using conventional cameras, such as a digital camera, a mobile phone or a PDA. Likewise, panorama shots can be taken with the invention from outlooks or mountain peaks; and also of historic places—with completely freely selectable angle. The image angle is not limited to 360°.

Panorama photos can be easily recorded with the invention: all that needs to be done is panning the recording device (digital camera, a mobile telephone and the like) in the desired angle while depressing the shutter release. Software installed on the recording device for controlled read-out of the image data from the image sensor, for analysis and composing the image data to the panorama image generates the recorded panorama image without additional user intervention. This is therefore a fully automatic method which does not require user interaction before, during or after the panorama image is recorded.

Exemplary embodiments of the invention will now be described with reference to the figures, which show in:

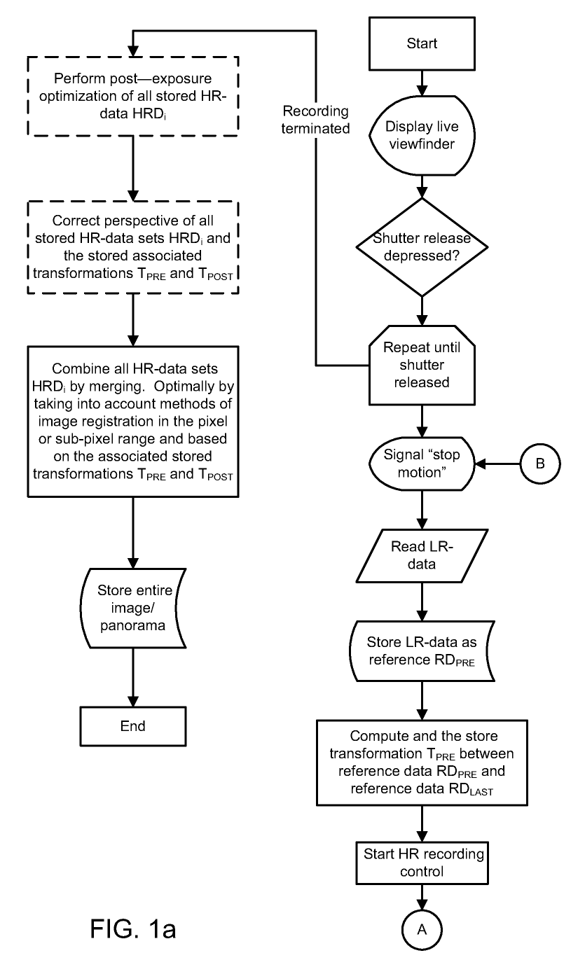

FIG. 1 an exemplary process flow during recordation of a panorama image,

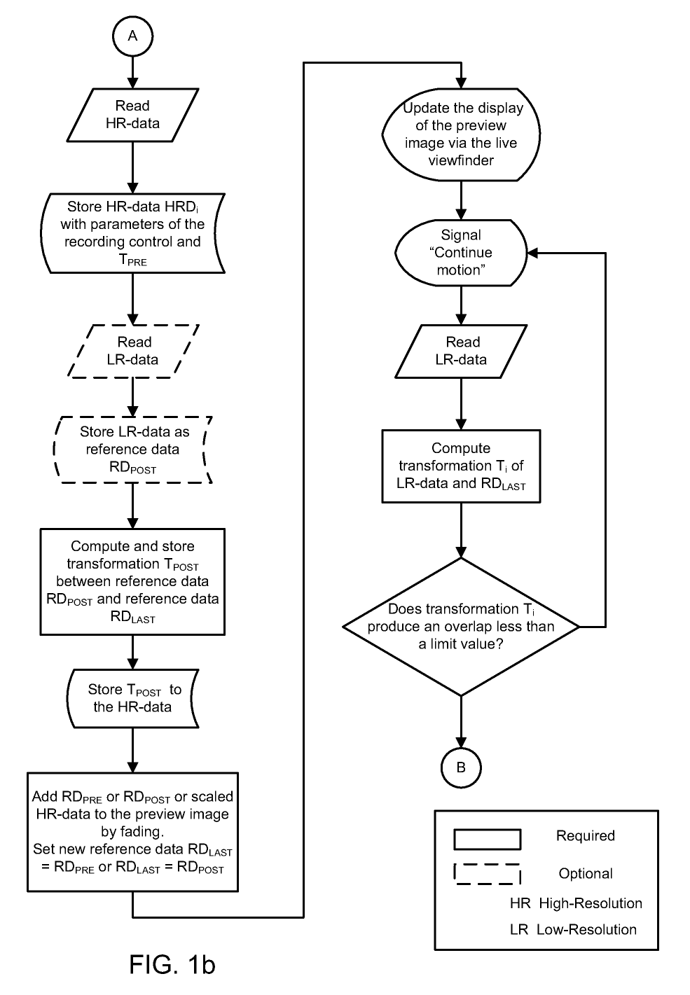

FIG. 2 a schematic diagram of the stored high-resolution images with overlapping regions.

The invention will now be described with reference to an exemplary digital camera. However, the invention is not limited to this particular exemplary embodiment, and embodiments of the invention can also be contemplated where the image sensor is arranged in other devices or instruments.

In the described exemplary embodiment, the image sensor which can be a CCD chip or a CMOS chip is integrated in a digital camera. In this embodiment, an optical unit with optical parameters, i.e., in this case an objective, is disposed in front of the image sensor, with the scenes to be recorded with the camera being imaged on the image sensor through the objective. To carry out the method of the invention, an algorithm is stored on a data processing device, e.g., a processor, integrated in the digital camera. The algorithm controls, in particular, read-out and analysis of the image data sets, as well as storing and combining the partial images into a aggregate image.

The method will now once more be briefly summarized:
1. Start: reading and storing the first image data set (first image is always used in this exemplary embodiment for the panorama),
2. Reading a second image data set and computing the overlapping region with the last stored image data set (e.g., by a 2-D transformation/Lukas-Kanade),
3. If the overlapping region is greater than a predetermined threshold value, deleting the current image data set and continuing with 2, otherwise continuing with 4,
4. Storing the image data set and inserting by superimposing on the panorama image,
5. Determining if the panorama memory is full or if the recording was terminated by a shutter release, if yes: STOP, otherwise continuing with 2.

In this exemplary embodiment, complete image data sets (in relation to the scene) are generally read out from the image sensor. The method can be accelerated by using for the analysis lower-resolution image data sets, instead of full image data sets. In the read-out process, individual images are rapidly and sequentially read out and analyzed, similar to a movie. An image can here be a complete data set of the sensor (full image), a partial image or a scaled image.

The data processing device reads a sensor data set, processes this data set preferably immediately and thereafter reads the next sensor data set. The read-out frequency with which the data sets of the image sensor are read, depends on the sensor and the data processing system as well as the desired system load or processing speed.

In an exemplary embodiment of the method of the invention, the analysis of the sensor data sets includes the following steps:
1. Optionally, performing a projection of the image, e.g., a cylindrical projection;
2. Determining a 2-D transformation between two consecutive image data sets by 2-D homography or a projection transformation, whereby the projection transformation is performed in a simple manner as Lukas-Kanade algorithm;
3. Summing the 2-D transformations until a predetermined threshold value is reached, and after reaching this threshold value, transitioning to the following step
4. Superimposing the current image on the preceding image(s) in overlapping fashion and storing the data in a data memory or a permanent memory. The stored image data set of the (partial) panorama image is thus successively augmented with the image data of the corresponding current image. Preferably, all image data of the panorama image are stored in a single file.

The steps of the recording process, i.e., reading, analyzing and storing the image data sets, continues for as long as the shutter release function remains activated, i.e., for as long as the desired scene is imaged.

In another exemplary embodiment of the processing method for image data sets, a projection of the entire panorama image is performed in a post-processing operation. Preferably, this is done particularly when the optional projection of the readout image data set did not occur in the aforementioned step 1.

In another exemplary embodiment of the processing method for image data sets, the projection for each individual data set is performed before or after the high-resolution data sets are stored, but before the transformation for combining the data sets is fine-tuned/recalculated and before the actual combination takes place. Preferably, this is done in particular when the optional projection of the read-out image data set was not performed in the aforementioned step 1.

In an exemplary embodiment of the method of the invention, the results from the analysis algorithm may be recorded and used to determine, preferably fully automatic and by taking into account the optical parameters of the objective (the optical unit), when an additional partial image of the scene must be stored and added to the already stored partial panorama image. The results of this evaluation by the analysis algorithm are then used to determine, preferably fully automatic, how the image data values of the image data set of the current partial image are to be added to the already stored partial image representing the partial panorama image. After the last image data set is added to the image data of the partial panorama image, a base data set of the aggregate panorama image is obtained. This data set of the aggregate panorama image can already represent the final version of the overall panorama image with corresponding image processing during the analysis and combining process. This may apply particularly if the projection is performed according to the aforementioned step 1 for each read-out data set of an individual image.

According to another exemplary embodiment, a post-processing step can be performed for the entire panorama image, wherein the panorama image is corrected, for example, with respect to distortions by taking into account the recorded motion data and the optical parameters of the objective. Performing this post-processing step is particularly advantageous if the aforementioned optional step 1 had been omitted.

In another exemplary embodiment of the method of the invention, the recorded results of the analysis algorithm can be used to continuously display to the user in a real-time preview on a display of the digital camera the progress during the combination of the image data into a panorama image.

According to another exemplary embodiment of the invention, the method for processing image data sets is integrated in the camera functionality of a mobile telephone, a PDA or also into the functionality of a digital camera. The software for controlling analysis and processing of the image data is here adapted to the operating system of the mobile telephone, the PDA or the digital camera, for example to one or more versions of the operating system Symbian®. The software is then preferably started in the camera mode of the device. Such integration makes it possible to access the full functionality of the corresponding camera function for panorama images. In particular, options for selecting a desired resolution, browser for paging through a photo gallery, zoom function and data transmission functions between the mobile terminal and an external memory, for example a memory card, or other data processing devices, for example a PC, can then also be readily utilized for panorama images.

In another exemplary embodiment, the method for processing image data sets is integrated in the camera functionality of a mobile telephone. With this approach, capture of a panorama photo is started by briefly depressing a joystick. The first recorded image is then displayed on the display or screen of the mobile telephone. Subsequent images are added to this first image by moving the mobile telephone to the left, to the right or vertically. The progress in generating the panorama photo is also displayed on the display or screen. The panorama photo is enlarged by the added image data. In this exemplary embodiment, the joystick needs to be briefly depressed a second time to conclude recording of the panorama photo. In another exemplary embodiment of the invention, the recording is terminated automatically when the maximum panorama size, for example 360°, is reached.

After the panorama photo has been recorded, the user can rotate the image immediately by 90°, if the image was recorded in portrait-format. The user can also take advantage of all functions made available in the camera mode of the mobile telephone; for example, the user can zoom in the panorama photo to check if quality and motif details meet expectations.

In one exemplary embodiment, the telephone keypad is used for navigating in a panorama photo. The keys can, for example, have the following functions:

### Key ‘5 ’:

Viewing a panorama photo in full resolution, i.e., a pixel of the image corresponds to a pixel of the display or the screen;

Keys ‘1’, ‘2’, ‘3’, ‘4’, ‘6’, ‘7’, ‘8’ and ‘9’: Shifting the panorama photo in the direction which corresponds to the position of the key depressed on the keypad relative to the key ‘5’, i.e. depressing the key ‘3’ reveals a detail of the panorama photo located to the left outside the detail currently displayed on the display or screen;

### Key ‘0’:

Displaying the entire panorama photo;

### Keys ‘*’ and ‘#’:

Stepwise zooming in or zooming out.

According to another exemplary embodiment of the invention, not only horizontal or vertical panorama photos, but also “poster formats” can be produced. In this embodiment, the camera is panned, for example, once horizontally (vertically) in one direction and subsequently panned back with an offset in height in the opposite direction, without interrupting the recording process, so that a second panorama photo is added above or below to the panorama photo produced during the first panning. Panning can be repeated several times in a meander pattern.

Post-processing will now be described in more detail:

FIGS. 1a and 1b represent an exemplary embodiment for implementing high-resolution stitching using post-processing.

For post-processing, all parameters of a recording (e.g., exposure time, ISO setting, white balance, aperture, focus, etc.) are stored (this is performed in many devices automatically in form of metadata in EXIF format which can be used for performing the method of the invention).

The exemplary high-resolution stitching with post-processing makes it possible to support a composite resolution, which cannot be held in volatile memory, by using memory-optimized methods, for example block-wise processing of the individual images in high resolution.

It further makes it possible to correct the perspective in individual images or the aggregate image, to adjust contrast, brightness and white balance by processing the parameters of the image acquisition control determined and stored for each individual image during a preferably complete image acquisition control, such as ISO setting, exposure time, aperture, white balance, color setting, as well as by processing the image information of overlapping regions which image the same scene segments with potentially different image acquisition parameters of the preferably complete image acquisition control.

### Post-Exposure Correction

FIG. 2 depicts the stored high-resolution images 1-4 as well as their determined overlapping regions A-C at the time when the images are optimally matched and before the images are combined into a single panorama image (see 100 in FIG. 1a). Recording parameters of the preferable complete image acquisition control (for example, exposure time, aperture, sensitivity/ISO setting, white balance, etc.) are stored for the individual images 1-4 (e.g., in the EXIF metadata, which are also written to the JPEG files by automatic encoding units).

Region A defines identical image contents with recording parameters of image 1 and image 2; the same applies to the subsequent images and the respective regions B and C.

Based on the information from the recording parameters, the images are matched pair-wise in a logical sequence, so that the correction to the totality of the individual images is as small as possible.

An individual image is corrected with respect to an adjacent image by determining for both images (e.g., by histogram analysis or by other analytical methods) a transformation for the parameters to be corrected (e.g., contrast, brightness, . . . ).

The same is done for compensating a difference in white balance between the individual images. If accurate information about the white balance is not available in the recording parameters (e.g., values of the actual color temperature), then the proper order is determined by analyzing the overlapping regions A-C and computing the correction for each image pair so as to keep the correction for the totality of the individual images as small as possible.

1-25. (canceled)

26. A method for processing image data sets of an image sensor, comprising the steps of:
reading from the image sensor at least partially several consecutive data sets,
analyzing the read-out data sets while reading out additional data sets,
automatically determining matching regions within the read-out data sets, and
producing an aggregate image by
storing data from several consecutive data sets together with information about the matching regions, or
storing data from several consecutive data sets in a single file, or
combining data from several consecutive data sets into a single image for outputting by data output means, or a combination thereof.

27. The method of claim 1, wherein the several consecutive data sets are read out during a continuous activation of a shutter release function.

28. The method of claim 1, wherein the aggregate image is produced from consecutive data sets read out during a one-time continuous activation of a shutter release function.

29. The method of claim 1, wherein a signal is sent out when another data set is added to the aggregate image.

30. The method of claim 1, wherein before producing the aggregate image, different recording parameters of the consecutive data sets are matched by analyzing overlapping image regions of individual data sets, wherein matching includes selecting an optimal sequence of the individual data sets so as to produce a smallest magnitude of changes of the recording parameters across all data sets.

31. The method of claim 1, wherein analyzing the read-out data sets comprises determining a 2-D transformation between consecutive data sets.

32. The method of claim 1, wherein analyzing the read-out data sets comprises determining when an additional partial images of a scene detected by the image sensor needs to be stored, or combining several partial images into a scene, or a combination thereof.

33. The method of claim 1, wherein the read-out data sets have different resolution.

34. The method of claim 8, wherein data sets having a low resolution are used to analyze the read-out data sets.

35. The method of claim 1, wherein data sets which are added to the stored data of the aggregate image are read out with high-resolution.

36. The method of claim 1, wherein the aggregate image represents a scene which is greater than a scene represented by a single data set of the image sensor.

37. The method of claim 11, further processing at least one of optical parameters or determined motion data to correct distortion of the stored data.

38. The method of claim 11, wherein the scene represented by the aggregate image is outputted continuously on a visual display.

39. A system for processing data sets of an image sensor, comprising:
at least one image sensor, and
at least one data processing device, wherein the at least one data processing device is configured to
read from the image sensor at least partially several consecutive data sets,
analyze read-out data sets while reading out additional data sets,
automatically determine matching regions within the read-out data sets, and
produce an aggregate image by
storing data from several consecutive data sets together with information about the matching regions, or
storing data from several consecutive data sets in a single file, or
combining data from several consecutive data sets into a single image for outputting by data output means, or a combination thereof.

40. The system of claim 14, wherein the at least one image sensor comprises a CCD sensor (CCD=Charge Coupled Device) or a CMOS sensor (CMOS=Complementary Metal Oxide Semiconductor).

42. The system of claim 14, further comprising:
at least one optical unit for imaging scenes on the at least one image sensor,
at least one activation unit for activating read-out of the data sets from the at least one image sensor, or
at least visual display of image data captured by the at least one image sensor,
or a combination thereof.

43. The system of claim 14, wherein the at least one image sensor is integrated in a mobile terminal.

44. A computer program which enables a computer, after the computer program is loaded into a memory of the computer, to execute a method for processing data sets of an image sensor, the method comprising the steps of:
reading from the image sensor at least partially several consecutive data sets,
analyzing the read-out data sets while reading out additional data sets,
automatically determining matching regions within the read-out data sets, and
producing an aggregate image by
storing data from several consecutive data sets together with information about the matching regions, or
storing data from several consecutive data sets in a single file, or
combining data from several consecutive data sets into a single image for outputting by data output means, or a combination thereof.

45. A computer-readable storage medium having stored thereon a program which enables a computer, after the computer program is loaded into a memory of the computer, to execute a method for processing data sets of an image sensor, the method comprising the steps of:
reading from the image sensor at least partially several consecutive data sets,
analyzing the read-out data sets while reading out additional data sets,
automatically determining matching regions within the read-out data sets, and
producing an aggregate image by
storing data from several consecutive data sets together with information about the matching regions, or
storing data from several consecutive data sets in a single file, or
combining data from several consecutive data sets into a single image for outputting by data output means, or a combination thereof.

46. The computer program of claim 18, wherein the computer program is downloaded from an electronic data network to a data processing device connected to the electronic data network.

47. The computer program of claim 20, wherein the electronic data network is the Internet.
